(19) United States
(12) Patent Application Publication
(10) Pub. No.: US 2018/0181990 A1
(43) Pub. Date: Jun. 28, 2018

(54) GENERATING AN INTERFACE AUGMENTING PRODUCT INFORMATION FROM VENDORS WITHIN A VENUE WITH CHARACTERISTICS OBTAINED FROM ADDITIONAL SOURCES

(71) Applicant: VenueNext, Inc., Santa Clara, CA (US)

(72) Inventor: Kyle Mitchell, Santa Clara, CA (US)

(21) Appl. No.: 15/389,119

(22) Filed: Dec. 22, 2016

(51) Int. Cl. G06Q 30/02

(52) U.S. Cl. CPC G06Q 30/0261

(57) ABSTRACT

Vendors associated with a venue provide product information to a venue management system, which generates an interface presenting the product information to users via an application associated with the venue management system and executing on client devices. One or more formatting rules are applied to the product information by the venue management system to generate the interface. The venue management system may augment product information provided by a vendor with information stored by the server or obtained from one or more sources other than the vendor. For example, the venue management system adds recipe information or nutritional information from a third party system to food items included in product information from a vendor or presents product information to users via the interface in an order that is based on prior purchases of products by the users.

### BACKGROUND

This invention relates generally to identifying products provided by vendors associated with a venue, and more specifically to a venue management system generating an interface by applying formatting rules to product information provided by vendors.

Venues such as stadiums, convention centers, or amphitheaters frequently host events that large numbers of users attend. These users compensate the venue in exchange for attending the venue during an event, providing revenue to the venue. Many venues also obtain additional revenue from vendors associated with the venue that provide products or services to users attending the venue.

However, if a large number of users attend a venue, congestion may impair many users' experience at the venue. For example, delays in placing orders with vendors or delays in vendors fulfilling received orders may discourage users from purchasing products or services from vendors associated with the venue, decreasing revenue to the vendor, which decreases revenue to the venue. While providing an application to client devices allowing users to purchase products or services from one or more vendors could expedite order placement with venues, different vendors may use different information to identify products or services or differently present information identifying products or services, which may cause a user to interact with different applications providing different interfaces to order. products or services from vendors associated with different venues or from different vendors associated with a venue. This increased complexity may discourage users from using applications to order products or services from vendors via the applications and from ordering products or services from vendors themselves.

### SUMMARY

A venue is a geographic location, such as a geographic location associated with one or more structures. Examples of a venue include a stadium, a convention center, an arena, a theater, an amphitheater, or other suitable structure or location where people may gather for an event. In various embodiments, users obtain a ticket to enter the venue, and various events are performed at the venue. Additionally, one or more vendors are associated with the venue and provide goods or services to users attending the venue. Examples of vendors include restaurants, food service providers, beverage providers, merchandise retailers, or other suitable entities providing products or services. Each vendor uses one or more terminals to identify products or services purchased by a user. Information received by a terminal used by a vendor to retrieve or to produce a product or to provide a service to a user who purchased the product or service. For example, the terminal is a point of sale terminal identifying products provided by a vendor and prices of various products provided by the vendor. When the terminal receives an input selecting a product provided by the vendor, instructions identifying the selected product and a request to retrieve or to produce the selected product are provided to the vendor, prompting the vendor to retrieve or to produce the selected product.

To improve user interaction with the venue, a venue management system is associated with the venue and maintains information associated with users and with vendors associated with the venue. The venue management system communicates information about the venue or about events occurring at the venue to client devices associated with users of the venue management system. Additionally, the venue management system receives orders for products or services from users and communicates the received orders to vendors associated with the venue to be fulfilled.

To allow users in a venue to more easily order products or services from one or more vendors, a venue management system provides an application executed by various client devices that allows users of the client devices to order products or services from one or more vendors associated with the venue. However, terminals used by different vendors or used by vendors in different venues may differently identify products or services provided by different vendors, so the application provided by the vendor differently presents information identifying products or services provided by different vendors or provided by vendors associated with different venues. For example, information identifying products or services from vendors associated with different venues may be presented in different orders or in different format in different orders or in different formats, which may increase a complexity of a user purchasing products or services via the application provided by the venue management system. To simplify purchase of products or services via the application provided by the venue management system and executing on a client device, the venue management system generates an interface for presentation by the application based on information obtained from terminals used by various vendors associated with one or more venues.

The venue management system receives product information describing products provided by one or more vendors from terminals associated with various vendors. Product information includes various characteristics of products provided by a vendor, such as product names and pricing information. By applying one or more formatting rules to product information received from a terminal, the venue management system an interface describing products that is subsequently transmitted to a client device for presentation to a user via an application executing on the client device that is associated with the venue management system. By generating the interface, the venue management system 250 may compensate for differences in how terminals used by different vendors to identify products or services to users and provide an interface that presents information describing products provided by various vendors in a consistent format, simplifying user selection or purchase of products by purchased by a user via the interface.

Formatting rules maintained by the venue management system map information describing one or more characteristics of products identified by a terminal used by a vendor to information describing formatting and presentation of the characteristics by the interface generated by the venue management system. For example, a formatting rule identifies types of characteristics of products received from a terminal and associates different types of characteristics with information describing presentation of the different types of characteristics. Another formatting rule may identify positions of different types of characteristics relative to each other in an interface presented by the venue management system, so characteristics of a product are presented in a consistent order relative to each other even when different terminals provide product information to the content selection module. In an embodiment, a formatting rule specifies presentation of a price of a product adjacent to a name of the product in the interface, while another formatting rules specifies that products having a specific value for a type of characteristic are presented in a region of the interface and products having an alternative value for the type of characteristic are presented in an another region of the interface. Hence, the formatting rules allow the interface generated by the venue management system to present characteristics of products received from various terminals in a standardized order relative to each other or in standardized positions relative to each other.

As different terminals may use different values for types of characteristics of products, the venue management system maintains different formatting rules for different terminals. For example, the venue management system associates different sets of formatting rules with different identifiers of terminals and retrieves a set of rules corresponding to an identifier of a terminal from which product information was received. Maintaining different formatting rules for different terminals allows the venue management system to account for variations in product information received from different terminals.

Additionally, the venue management system may augment information about products received from a terminal by obtaining characteristics of products identified by the terminal from one or more sources other than the terminal. A source may be a third party system external to the venue management system or may be the venue management system. For example, the venue management system obtains information describing characteristics of a product identified by a terminal by communicating a request identifying the product to a third party system, which provides the information describing characteristics of the identified product to the venue management system. In various embodiments, the request to the third party system includes a product identifier corresponding to a product, a name of the product, a description of the product, or other information identifying the product to the third party system. The venue management system may additionally or alternatively access locally stored information, such as user profiles or actions stored by the venue management system, or information accessible to the venue management system from a third party system (e.g., connections between users maintained by a third party system that the users have authorized the venue management system to access). For example, the venue management system identifies prior purchases of a product by a user from information stored by the venue management system or prior purchases of the product by other users connected to the user via a third party system.

The venue management system may also obtain characteristics of products identified by a terminal from the one or more sources, and different characteristics may be obtained for different types of identified products. For example, if an identified product is a food item, the venue management system obtains one or more of: nutritional information of the identified product, ingredients of the identified product, and recipe information of the identified product. Different characteristics may be obtained from different sources. In the preceding example, nutritional information may be obtained from a particular website (i.e., a third party system), while recipe information may be obtained from a different website (i.e., a different third party system). As another example, if an identified product is an article of clothing, the venue management system obtains one or more of: sizing information, care information, complementary articles of clothing from one or more sources. The venue management system may also obtain reviews of various identified products from one or more sources other than the terminal.

The venue management system applies the one or more formatting rules to characteristics of products received from a terminal and characteristics of products obtained from one or more sources to generate the interface. Hence, the venue management system augments characteristics of products specified by a vendor via the terminal with additional characteristics obtained from the one or more sources, with the formatting rules identifying the types of characteristics presented by the interface. For example, application of the formatting rules generates an interface providing a menu of food items presenting a name and a price of a food item received from the terminal in conjunction with nutritional information and ingredients of the food item obtained from one or more sources other than the terminal. Additionally, the formatting rules applied by the venue management system modify presentation of information describing products based on information associated with a user to whom the interface is to be presented. For example, a formatting rule orders information describing products identified by the terminal based on a number of times the user has previously purchased products or based on preferences in the user's user profile that match characteristics of different products. The venue management system transmits the generated interface to a client device associated with a user to present the interface to the user, which allows the user to purchase products from the vendor via the application.

### BRIEF DESCRIPTION OF THE DRAWINGS

FIG. 1 is a block diagram of a venue, in accordance with an embodiment.

FIG. 2 is a block diagram of a system environment including a venue management system, in accordance with an embodiment.

FIG. 3 is a block diagram of a venue management system, in accordance with an embodiment.

FIG. 4 is a flowchart of a method for generating an interface describing products provided by a vendor associated with a vendor, in accordance with an embodiment.

The figures depict various embodiments for purposes of illustration only. One skilled in the art will readily recognize from the following discussion that alternative embodiments of the structures and methods illustrated herein may be employed without departing from the principles of described herein.

### DETAILED DESCRIPTION

### Venue Overview

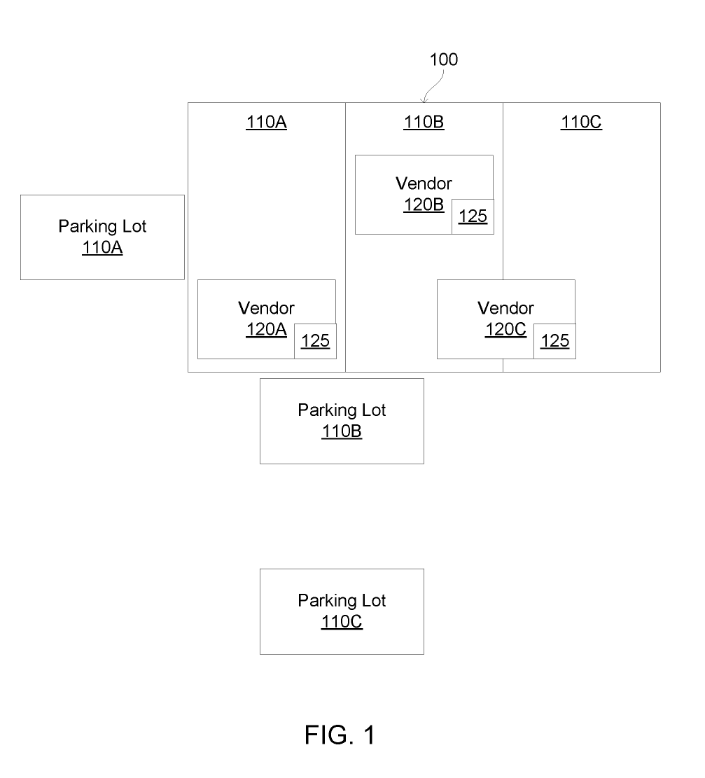

FIG. 1 is a block diagram of one embodiment of a venue 100. In the example of FIG. 1, the venue includes multiple regions 110A, 110B, 110C (also referred to individually and collectively using reference number 110). Additionally, one or more vendors 120A, 120B, 120C (also referred to individually and collectively using reference number 120) are included in the venue 100, and one or more parking lots 130A, 130B, 130C (also referred to individually and collectively using reference number 130) are associated with the venue 100. However, in other embodiments, different and/or additional components may be associated with or included in the venue 100.

The venue 100 is a geographic location, such as a geographic location associated with one or more structures. Examples of a venue 100 include a stadium, a convention center, an arena, a theater, an amphitheater, or other suitable structure. One or more regions 110 are included in the venue 100, with each region 110 corresponding to an area including a set of locations within the venue 100. For example, different regions 110 correspond to different sections of a stadium, different aisles of a stadium or arena, different rooms in a convention center, or any other suitable area within the venue 100. In some embodiments, an area within the venue 100 is associated with multiple regions 110 having different levels of precision. For example, a specific seat in a venue 100 is associated with a region 110 identifying a section including the seat, another region 110 identifying an aisle within the section including the seat, and an additional region identifying the specific seat. While FIG. 1 shows an example venue 100 including three regions 110A, 110B, 110C, in other embodiments, a venue 110 may include any number of regions 110.

One or more vendors 120 are included in the venue 110, with each vendor providing products or services to users within the venue 110. Examples of vendors 120 include restaurants, food service providers, beverage providers, merchandise retailers, or other suitable entities providing products or services. Different vendors 120 may be associated with different regions 110 of the venue. For example, a vendor 120A is associated with a region 110A, while a different vendor 120B is associated with a different region 110B. A vendor 110 may be associated with multiple regions 110; for example, a vendor 110C is associated with a region 110B as well as with an additional region 110C. In some embodiments, a vendor 120 is associated with a region 110 based on a distance between the vendor 120 and the region 110. For example, the vendor 120 is associated with a region 110 having a minimum distance from a location associated with the vendor 120. If a location associated with a vendor 120 is within a region 110, the vendor 120 is associated with the region 110 including the vendor's associated location.

Various vendors 120 use one or more terminals 125 to identify products or services purchased by a user. Additionally, information received by a terminal 125 is used by a vendor 120 to retrieve or to produce a product or to provide a service to a user who purchased the product or service. As an example, information identifying a product is provided to a terminal 125, which generates instructions for the vendor 120 to produce or retrieve the identified product and obtain compensation from a user for the identified product. In various embodiments, the terminal 125 is a point of sale terminal identifying products provided by a vendor 120 and prices of various products provided by the vendor 120. When the terminal 125 receives an input selecting a product provided by the vendor 120, instructions identifying the selected product and a request to retrieve or to produce the selected product are provided to the vendor 120, prompting the vendor 120 to retrieve or to produce the selected product. Different vendors 120 may use different types of terminals 125 that maintain different values for characteristics of products or differently order characteristics of products or services. For example, vendors 120 associated with different venues 100 use different types of terminal 125 that differently present information identifying products or services provided by vendors 120 associated with different venues 100.

Additionally, one or more parking lots 130A, 130B, 130C are associated with the venue 110 and identify physical locations for parking vehicles. Each parking lot includes one or more spaces, each space for parking a vehicle. A price is associated with each parking lot 130 specifying an amount of compensation a user provides to an entity associated with the venue 110 for a space in the parking lot 130 to be allocated for parking a vehicle associated with the user. Different parking lots 130 may have different distances from the venue 110, and prices associated with different parking lots 130 may be inversely proportional to a distance between a parking lot 130 and the venue 110. Each parking lot 130 is also associated with a capacity specifying a maximum number of vehicles that may be parked in a parking lot 130. The capacity may be total number of spaces in the parking lot 130 or may be a maximum number of vehicles. Information may be maintained by one or more devices included in a parking lot 130 specifying a number of spaces in the parking lot 130 in which vehicles are parked, specifying a number of vehicles within a geographic area associated with the parking lot 130, or any other suitable information. For example, a device included in the parking lot 130 increments a counter when a vehicle enters the geographic area associated with the parking lot 130 or when a vehicle is parked in a space of the parking lot 130.

### System Architecture

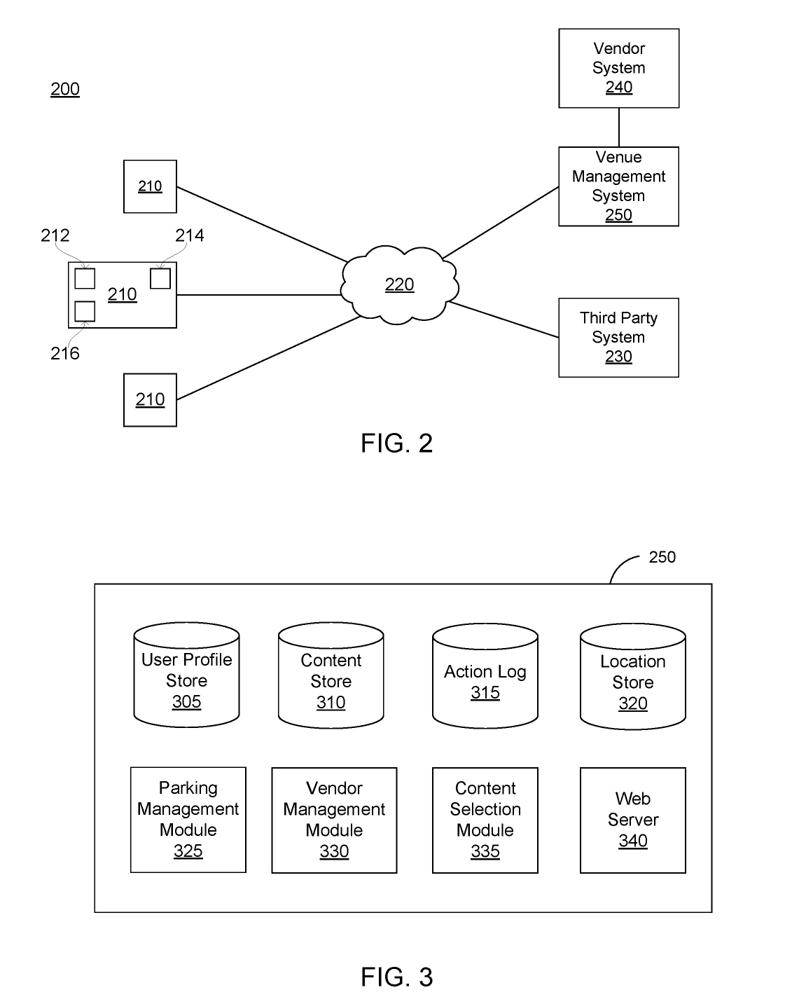

FIG. 2 is a block diagram of a system environment 200 for a venue management system 250. The system environment 200 shown by FIG. 1 includes various client devices 210, a network 220, a third party system 230, one or more vendor systems 240, and a venue management system 250. In alternative configurations, different and/or additional components may be included in the system environment 200. The embodiments described herein may be adapted to online systems other than venue management systems.

A client device 210 is one or more computing devices capable of receiving user input as well as transmitting and/or receiving data via the network 220. In one embodiment, the client device 210 is a conventional computer system, such as a desktop computer or a laptop computer. Alternatively, the client device 210 may be a device having computer functionality, such as a personal digital assistant (PDA), a mobile telephone, a smartphone or another suitable device. A client device 210 is configured to communicate with other devices via the network 220. In one embodiment, the client device 210 executes an application allowing a user of the client device 210 to interact with the venue management system 250. For example, the client device 210 executes a browser application to enable interaction with the venue management system 250 or with one or more third party system 230 via the network 220. In another embodiment, a client device 210 interacts with the venue management system 250 through an application programming interface (API) running on a native operating system of the client device 210, such as IOS® or ANDROID™.

A display device 212 included in a client device 210 presents content items to a user of the client device 210. Examples of the display device 212 include a liquid crystal display (LCD), an organic light emitting diode (OLED) display, an active matrix liquid crystal display (AMLCD), or any other suitable device. Different client devices 210 may have display devices 212 with different characteristics. For example, different client devices 212 have display devices 212 with different display areas, different resolutions, or differences in other characteristics.

One or more input devices 214 included in a client device 210 receive input from the user. Different input devices 214 may be included in the client device 210. For example, the client device 210 includes a touch-sensitive display for receiving input data, commands, or information from a user. Using a touch-sensitive display allows the client device 210 to combine the display device 212 and an input device 214, simplifying user interaction with presented content items. In other embodiments, the client device 210 may include a keyboard, a trackpad, a mouse, or any other device capable of receiving input from a user. Additionally, the client device may include multiple input devices 214 in some embodiments. Inputs received via the input device 214 may be processed by an application associated with the venue management system 250 and executing on the client device 210 to allow a client device user to exchange information with the venue management system 250.

Additionally, a client device 210 may include one or more position sensors 216, which determine a physical location associated with the client device 210. For example, a position sensor 216 is a global positioning system (GPS) sensor that determines a location associated with the client device 210 based on information obtained from GPS satellites communicating with the GPS sensor, such as coordinates specifying a latitude and longitude of the location associated with the client device 210. As another example, a position sensor 216 determines a location associated with the client device 210 based on intensities of signals received from one or more access points (e.g., wireless access points) by the client device 110. In the preceding example, the position sensor 216 determines a location associated with the client device 210 based on signal intensity between the client device 210 and one or more wireless access points and service set identifiers (SSIDs) or media access control (MAC) addresses of the wireless access points. However, the client device 210 may include any suitable type of position sensor 216. In various embodiments, the client device 210 may include multiple position sensors 216.

The network 220 may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 130 may be coupled to the network 220 for communicating with one or more client devices 110 or with the venue management system 250. In one embodiment, a third party system 230 is an application provider communicating information describing applications for execution by a client device 210 or communicating data to client devices 110 for use by an application executing on the client device 210. In other embodiments, a third party system 230 provides content or other information for presentation via a client device 210. For example, a third party system 230 provides content related to an event occurring at the venue 110 to a client device 210 for presentation to a user; as an example, the third party system 230 provides video or audio data of a portion of an event occurring at the venue to a client device 210, allowing a user associated with the client device 210 to view the portion of the event from an alternative vantage point than the user's vantage point or to hear commentary about the portion of the event. As another example, a third party system 230 is a social networking system maintaining connections between various users and providing content for presentation to users based at least in part on the maintained connections. A third party system 230 may also communicate information to the venue management system 250, which subsequently communicates the information, or a portion of the information, to one or more client devices 110 via the network 220.

Additionally, one or more vendor systems 240 are coupled to the venue management system 250 via the network 220 or through direct connections between the vendor systems 240 and the venue management system 250. A vendor system 240 is associated with a vendor 120 and receives orders for products or services from the venue management system 250 and provides the products or services identified by the orders. Further, a vendor system 240 provides the venue management system 250 with information describing fulfillment of orders by a vendor 120 associated with the vendor system 240. For example, the vendor system 240 provides information to the venue management system 250 specifying an estimated time to fulfill subsequently received or pending orders for products or services, an average time in which previously received orders were fulfilled, a number of unfulfilled orders received by the vendor system 240, or other suitable information. Information provided from the vendor system 240 to the venue management system 250 accounts for orders received via the venue management system 250 as well as orders received by the vendor 120 associated with the vendor system 240 from users visiting a location associated with the vendor 120.

Additionally, a vendor system 240 may provide information to the venue management system 250 describing products or services sold by a vendor 120 associated with the vendor system 240. For example, the vendor system 240 identifies a number of different products or services 140 sold by the vendor 120 or identifies an amount of revenue received by the vendor 120 in exchange for different products or services. Information describing sold products or services may be communicated from the vendor system 240 to the venue management system 250 as the products or services are sold or may be communicated from the vendor system to the venue management system 250 at periodic intervals. Additionally, the venue management system 250 may request information describing sales of products or services to a vendor system 240, which provides the requested information to the venue management system 250 in response to receiving the request.

The venue management system 250, which is further described below in conjunction with FIG. 3, receives content from one or more third party systems 230 or generates content and provides content to users via an application associated with the venue management system 250 and executing on client devices 210. Additionally, the venue management system 250 maintains information associated with one or more parking lots 130 associated with a venue 100, such as a number of spaces in a parking lot 130 currently occupied, a price associated with a the parking lot 130, or a number of spaces in the parking lot 130 that have been purchased, as well as directions for navigating to a location associated with the parking lot 130. The venue management system 250 may communicate certain information associated with a parking lot 130 to one or more users, such as the price associated with the parking lot 130 or directions to the location associated with the parking lot 130. Associations between one or more vendors 120 and regions 110 of the venue 100 are also included in the venue management system 250, which also receives orders for products or services from one or more users and communicates the orders to one or more vendors 120 for fulfillment.

FIG. 3 is a block diagram of an architecture of a venue management system 250. The venue management system 250 shown in FIG. 3 includes a user profile store 305, a content store 310, an action log 315, a location store 320, a parking management module 325, a vendor management module 330, a content selection module 335, and a web server 340. In other embodiments, the venue management system 250 may include additional, fewer, or different components for various applications. Conventional components such as network interfaces, security functions, load balancers, failover servers, management and network operations consoles, and the like are not shown so as to not obscure the details of the system architecture.

Each user of the venue management system 250 is associated with a user profile, which is stored in the user profile store 305. A user profile includes declarative information about the user provided by the user and may also include information inferred by the venue management system 250 from actions associated with the user or from other information. In one embodiment, a user profile includes multiple data fields, each describing one or more attributes of the corresponding user. Examples of information stored in a user profile include demographic information, contact information, preferences, and location information. For example, a user profile identifies a region 110 of the venue 100 associated with a user, such as a region 110 including a seat associated with a ticket to attend the venue 100 associated with the user. A user profile may also store other information provided by the user, for example, image data or video data. Additionally, a user profile in the user profile store 205 may also maintain references to actions by the corresponding user performed on content presented by the venue management system 250 or interactions between the corresponding user captured by one or more vendor systems 240 and communicated to the venue management system 250. For example, a user profile identifies prior orders for products or services the venue management system 250 received from a user and communicated to one or more vendor systems 150.

In some embodiments, a user profile includes a status associated with the user. The venue management system 250 may provide different functionality to a user based on the user's status. For example, the venue management system 250 communicates certain types of messages to client devices 210 associated with users having a specific type of status and does not communicate the certain types of messages to client devices 210 associated with users that do not have the specific type of status. As another example, the venue management system 250 presents less advertisement content to users having specific statuses. The status may be based on a frequency with which the user is associated with tickets to attend the venue 100 or an amount of money the venue management system 250 has received from the user (e.g., based on an amount the user has spent on tickets to attend the venue 100). Additionally, a user may provide an amount of compensation to the venue management system 250 for a specific status to be associated with the user. For example, the user provides the venue management system 250 with an amount of compensation per year or per month for the venue management system 250 to associate a specific status with the user.

The content store 310 stores objects that each represents various types of content received from one or more third party systems 230 or generated by the venue management system 250. Examples of content represented by an object include video data associated with an event occurring at the venue 100, image data associated with an event occurring at the venue 100, audio data associated with an event occurring at the venue 100, text data associated with an event occurring at the venue 100, information associated with the venue 100 or with the location of the venue 100, or other suitable. Additionally, content may be received from applications associated with a third party system 230 and executing on client devices 210 associated with users of the venue management system 230. In one embodiment, objects in the content store 210 represent single pieces of content, or content “items.”

The action log 315 stores information describing actions performed by venue management system users internal to or external to the venue management system 250. For example, actions performed by a user on a third party system 230 that communicates information to the venue management system 250 are stored in the action log 315 along with information describing actions performed by the user through the venue management system 250. Examples of actions include: ordering a product or service from a vendor 120 included in the venue 100, checking-into the venue, accessing content provided by the venue management system 250 or provided by a third party system 230 that communicates with the venue management system 250, providing a review of a product, service, or vendor 120 to the venue management system 250 or to a third party system 230 that communicates with the venue management system 250, providing a comment associated with the venue 100 or with an event occurring at the venue 100 to the venue management system 250 or to a third party system 230 that communicates with the venue management system 250. However, any suitable action may be stored in the action log 315 and associated with a user profile in the user profile store 305. Information in the action log 315 may identify the user performing an action, a type of the action, a description of the action, a time associated with the action, or any other suitable information. In some embodiments, data from the action log 315 is used to infer interests or preferences of a user, augmenting interests included in the user's user profile and allowing a more complete understanding of user preferences.

The action log 315 may also store user actions taken on a third party system 230, such as an external website, and communicated to the venue management system 250. For example, an e-commerce website may recognize a user of the venue management system 250 through a plug-in enabling the e-commerce website to identify the venue management system user. Because users of the venue management system 250 are uniquely identifiable, third party systems 230 may communicate information about a user's actions outside of the venue management system 250 to the venue management system 250 for association with the user. Hence, the action log 315 may record information about actions users perform on a third party system 230, such as purchases made, comments on content, or other information a user authorizes a third party system 230 to communicate to the venue management system 250.

The location store 320 includes physical locations associated with various regions 110 of the venue 100. In various embodiments, the location store 320 includes a region identifier associated with each region 110 and information identifying a geographic area associated with the region identifier. Any suitable information may identify the geographic area associated with a region identifier. Example information identifying a geographic area of a region 110 include: physical coordinates specifying boundaries of a region 110 and an identifier of a portion of the venue 100 including the region 110. Additionally, the location store 320 includes data associating vendors 120 with one or more regions 110 of the venue 100. A vendor identifier uniquely associated with a vendor 120 is associated with a region identifier, with the association stored in the location store 320. Multiple vendors 120 may be associated with a region 110 of the venue 100.

In some embodiments, the location store 320 also associates location information with users of the venue management system 250. A client device 210 communicates location information to the venue management system 250, which may store the location information in the location store 320 or in the user profile store 305 in association with the user. Based on the received information, the venue management system 250 may determine a region 110 of the venue including the location information and associate the region identifier of the determined region with a user profile corresponding to the user. If the venue management system 250 receives modified location information from the client device 210, the venue management system 205 may modify the determined region 110 if a different region includes the modified location information. Alternatively, one or more sensors included in the venue 100 identify a client device 210 and determine a location associated with the client device 210. Based on the determined location, the venue management system 250 identifies a region 110 including the client device 110 and stores a region identifier of the region 110 in association with a user identifier of a user associated with the client device 210. In various embodiments, information identifying a location associated with the client device 210 (e.g., latitude and longitude) is also stored in the location store 320 in association with an identifier associated with the user associated with the client device 210. Additionally, the venue management system 250 may assign a location to a user and store the assigned location in association with the user in the location store 320. For example, when a user purchases a ticket to enter the venue 100, the ticket is associated with a location assigned to the user, and the location store 320 includes information associating the location assigned to the user from the ticket with an identifier associated with the user.

The parking management module 325 includes information identifying parking lots 130 associated with the venue and describing various parking lots 130. Each parking lot 130 is associated with a lot identifier that uniquely identifies a parking lot 130. Characteristics of a parking lot 130 are stored in the parking management module 325 in association with a lot identifier corresponding to the parking lot 130. Characteristics of a parking lot 130 include a capacity for the parking lot 130 that specifies a maximum number of vehicles capable of being parked in the parking lot 130 and a price associated with the parking lot 130 for allocating a space in the parking lot 130 to a vehicle. Additional characteristics of a parking lot 130 include one or more locations associated with the parking lot 130 (e.g., entrances) and directions to the location associated with the parking lot 130. Directions from one or more locations associated with the parking lot 130 to the venue 100 may also be maintained by the parking management module 325.

Certain characteristics of a parking lot 130 are modified based on information is received by the venue management system 250. As users purchase spaces in a parking lot 130, the parking management module 325 maintains a number of purchased spaces associated with the parking lot 130. Additionally, when a vehicle enters a parking lot 130, information is communicated from the parking lot to the venue management system 250, where the parking management module 325 maintains a number of vehicles currently occupying the parking lot 130 or a number of currently occupied spaces in the parking lot 130. In some embodiments, a ticket is scanned or other information is captured by a device (e.g., scanner, card reader, terminal) when a vehicle enters the parking lot 130; the device communicates an indication that information was captured to the venue management system 250, causing the parking management module 325 to increment a number of spaces in the parking lot 130 currently associated with vehicles or to increment a number of currently occupied spaces in the parking lot 130. Thus, the parking management module 325 maintains a number of spaces in a parking lot 130 that are currently occupied by vehicles and modifies the number of currently occupied spaces as vehicles are parked in the parking lot.

Based on a number of spaces currently associated with vehicles in various parking lots 130, the parking management module 325 may communicate messages to client devices 210 identifying one or more of the parking lots 130. In one embodiment, the parking management module 325 selects a parking lot 130 based on a difference between a number of previously purchased spaces in the parking lot 130 and a number of currently occupied spaces in the parking lot 130. For example, the parking management module 325 selects a parking lot 130 having at least a threshold difference between a number of previously purchased spaces and a number of currently occupied spaces, which indicates there are at least the threshold number of unoccupied spaces in the selected parking lot 130. To increase the number of vehicles in the selected parking lot 130, the parking management module 325, the parking management module communicates a message to client devices 110 associated with one or more users identifying the selected parking lot. The message may indicate a number of unoccupied spaces in the selected parking lot 130 as well as the price associated with the selected parking lot 130. In some embodiments, the parking management module 325 modifies the price associated with the selected parking lot 130 to encourage users to park vehicles in spaces of the selected parking lot. The parking management module 235 may also modify a price associated with the selected parking lot 130 to encourage users to park vehicles in spaces of the selected parking lot 130. For example, the parking management module 325 decreases a price of the selected parking lot 130 to increase likelihoods of users purchasing spaces in the selected parking lot 130.

The parking management module 325 also receives information describing traffic conditions within a threshold distance of the parking lot 130 associated with the user and determines the directions for communication to the user based at least in part on the traffic conditions. Information describing the traffic conditions includes a number of currently occupied spaces in one or more additional parking lots 130, such as additional parking lots 130 within a threshold distance of the parking lot 130 associated with the user. Based on the information describing the traffic conditions, the parking management module 325 may modify the directions to one or more locations associated with the parking lot associated with the user. For example, the parking management module 325 modifies the directions to a location associated with the parking lot 130 to avoid one or more additional parking lots 130 with at least a threshold number of currently occupied spaces or to avoid one or more geographic regions having at least a threshold number or density of vehicles. As traffic conditions change, the parking management module 325 may further modify the direction to a location associated with the parking lot 130 and communicate the further modified directions to the client device 210 associated with the user, allowing a user to bypass congestion when travelling to the parking lot 130 associated with the user.

The vendor management module 330 receives orders for products or services from client devices 210 associated with users and communicates the orders to one or more vendor systems 240 of vendors 120 associated with the venue 100. In various embodiments, the vendor management module 330 includes vendor profiles each associated with one or more vendors 120 associated with the venue 100. A vendor profile includes a vendor identifier uniquely identifying a vendor 120 and additional information associated with the vendor 120, such as one or more regions 110 of the venue 100 associated with the vendor 120 and information for communicating with a vendor system 240 associated with the vendor 120. Further examples of information associated with the vendor 120 and included in a vendor profile include: contact information, hours of operation, a listing of products or services provided by the vendor 120, a current inventory or products maintained by the vendor 120, and a current time for the vendor 120 to fulfill received orders. However, in other embodiments, additional or different information may be included in the vendor profile. One or more users authorized by the venue management system 250 may communicate information to the vendor management module 330 to modify regions 110 of the venue 100 associated with one or more vendors 120.

When the vendor management module 330 receives an order identifying a product or service and identifying a vendor 120 from a user, the vendor management system 330 communicates the order to a vendor system 240 corresponding to the identified vendor 120. The vendor 120 may subsequently deliver the product or service identified by the order to the user or may communicate a notification to the user via the venue management system 250 when the order is fulfilled. To expedite delivery of products or services, the vendor management module 330 may associate different vendors 120 with different regions 110 of the venue 100 to reduce time for users to receive products or services delivered by vendors 120. The vendor management module 330 may modify regions 110 of the venue 100 associated with a vendor 120 by modifying identifiers of regions 110 included in a vendor profile of a vendor 120. In some embodiments, the vendor management module 330 modifies regions 110 associated with a vendor 120 based on a number or a frequency of orders received from users associated with different regions 110 as well as a time to fulfill orders by different vendors 120, products or services offered by different vendors 120 or a number of orders received by different vendors 120. When modifying regions 110 associated with a vendor 120 or vendors 120 associated with a region, the vendor management module 330 may account for products or services provided by various vendors 120 so similar products or services are provided to users in a region 110 before and after modification of the vendors 120 associated with the region 110.

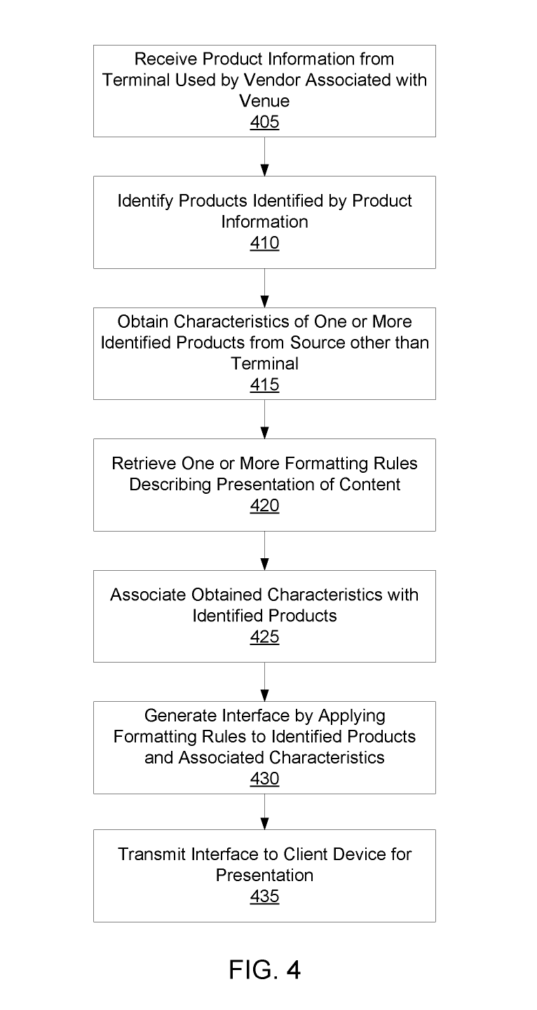

In various embodiments, the vendor management module 330 determines vendors 120 to which orders received from users are communicated based on times for various vendors 120 to fulfill received orders. The vendor management module 330 may account for various criteria when determining a vendor 120 to receive an order from a user received by the vendor management module 330. For example, the vendor management module 330 obtains locations for multiple vendors 120 in the venue 100 and times for each of vendors 120 to fulfill received orders, as further described below in conjunction with FIG. 4, along with products or services provided by each of the vendors 120. When the vendor management module 330 receives an order from a user, the vendor management module 330 identifies multiple vendors 120 providing a product or a service included in the order and retrieves locations for each of the identified vendors 120 and times for each of the vendors 120 to fulfill received orders. Based on the locations in the venue 100 of each of the identified vendors 120 and the times for each of the identified vendors 120 to fulfill received orders, the vendor management module 330 determines a vendor 120 and communicates the order to the determined vendor 120. For example, the vendor management module 330 communicates the order to an identified vendor 120 having a minimum time to fulfill received orders and having a location in the venue 100 less than a threshold distance to a location of at least one other identified vendor 120 in the venue 100. As another example, the vendor management module 330 communicates the order to an identified vendor 120 having a minimum time to fulfill received orders and having a distance between the location in the venue 100 of the identified vendor 120 and a location associated with the order that is within a threshold amount of a distance between the location in the venue 100 of at least one other identified venue and the location associated with the order. Determining a vendor 120 to which an order is communicated is further described below in conjunction with FIG. 4.

Various vendors 120 may use delivery personnel to deliver products or services to users who ordered the products or services from different locations within the venue 100. This allows users in the venue 100 to more conveniently obtain products or services from the vendor 120 by allowing the users to obtain the products or services 100 without physically going to the location in the venue 100 of the vendor 120. The venue management system 250 obtains information for an amount of usage of delivery personnel by one or more vendors 120 to deliver products or services. An amount of usage of delivery personnel by a vendor 120 is an amount of time spent by delivery personnel delivering products or services from the vendor 120 to users within a specific time interval. In an embodiment, the venue management system 250 associates a different identifier with different delivery personnel and captures information identifying an amount of time individual delivery personnel spent delivering products or services from the vendor 120 to users within a time interval (e.g., an hour interval) and maintains a percentage of the time interval spent by individual delivery personnel delivering products or services from the vendor 120 and vendors 120 associated with individual deliver personnel. Based on the percentages of the time interval spent by various delivery personnel delivering products or services, the vendor management module 330 determines an average percentage of the time interval during which delivery personnel delivered products or services to users for various vendors 120. As another example, vendors 120 maintain times for different delivery personnel to deliver products or services to users who ordered the products or services and maintains an average amount of time for delivery personnel to deliver products or services to users from the maintained times and provide the maintained times to the vendor management module 330, which stores the maintained times in association with identifiers of delivery personnel and with vendors 120.

In various embodiments, the vendor management module 330 modifies associations between delivery personnel and vendors 120 based on amounts of usage of delivery personnel by various vendors 120. For example, the vendor management module 330 modifies an association of delivery personnel with a vendor 120 having less than a threshold usage of delivery personnel to an association with an additional vendor 120, such as an additional vendor 120 having greater than the threshold usage of delivery personnel or having greater than an additional threshold usage of delivery personnel. The vendor management module 330 may account for order volumes at different vendors 120 when modifying associations between delivery personnel and vendors 120 in addition to the amounts of usage of delivery personnel by various vendors 120. For example, the vendor management module 330 modifies associations of delivery personnel with vendors 120 having less than a threshold usage of delivery personnel to associations with vendors 120 having at least a threshold number of pending orders or to associations with vendors 120 having at least a threshold rate at which orders are received. The vendor management module 330 may also modify associations between delivery personnel and vendors 120 based on distances between locations in the venue 100 of various vendors 120, so delivery personnel is associated with other vendors 120 having locations in the venue 100 less than a threshold distance from locations in the venue 100 associated with vendors 120 with which the delivery personnel was originally associated.

Additionally, the vendor management module 330 receives information from a vendor system 240 and communicates the information to one or more client devices 210 for presentation to users. For example, the vendor system 240 communicates a time to fulfill an order, an estimated time to fulfill an order, a number of previously received orders that have yet to be fulfilled, or other suitable information to the vendor management module 330, which provides at least a subset of the information to a client device 210 for presentation to a user. As another example, a vendor system 240 communicates a message to the vendor management module 330 including a user identifier, an order identifier (or a description of an order), and an indication that an order corresponding to the order identifier has been fulfilled by a vendor. The vendor management module 330 identifies a user corresponding to the user identifier from the user profile store 305 and communicates the message to a client device 210 associated with the user.

As vendors 120 may deliver products to users in various regions 110 of the venue 100 to fulfill orders received from various users, in some embodiments, the vendor management module 330 regulates communication of orders received from client devices 210 associated with users to vendor systems 240 associated with various vendors 120. When the vendor management module 330 receives an order for a product or a service from a client device 210 associated with a user, the vendor management module 330 stores the received order in a queue for a specified time interval before communicating the order to a vendor system 240 corresponding to a vendor 120 identified by the order. If the vendor management module 330 receives additional orders from users having one or more characteristics matching or similar to the order stored in the queue and identifying the vendor 120 identified by the order while the order is stored in the queue, the vendor management module 330 generates a group including the additional orders and the order stored in the queue and communicates the group or orders to a vendor system 240 associated with the vendor 120 to be fulfilled. For example, the vendor management module 330 generates a group including additional orders associated with users having a location matching a location of a user associated with an order stored in the queue. As additional examples, the vendor management module 330 generates a group including orders identifying products or services matching, or similar to, a product or service specified by an order stored in the queue or generates a group including orders identifying products or services having times for fulfillment within a threshold value of a time for fulfillment of the order stored in the queue. Communicating a group of orders having one or more matching or similar characteristics to a vendor system 240 allows the vendor 120 associated with vendor system 240 to more efficiently fulfill orders from users.

The content selection module 335 selects one or more content items for communication to a client device 210 for presentation to a user. Content items eligible for presentation to the user are retrieved from the content store 310, from a third party system 230, or from another source, by the content selection module 335, which selects one or more of the content items for presentation to the user. A content item eligible for presentation to the viewing user is a content item associated with at least a threshold number of targeting criteria satisfied by characteristics of the user or is a content item that is not associated with targeting criteria. For example, a content item associated with targeting criteria specifying a threshold distance of the venue 100 is identified as eligible for presentation to users associated with locations within a threshold distance of the venue 100. As another example, a content item associated with targeting criteria specifying attendance of an event at the venue 100 is identified as eligible for presentation to users attending the event or who have indicated they will attend the event. In various embodiments, the content selection module 335 includes content items eligible for presentation to the user in one or more selection processes, which identify a set of content items for presentation to the user. For example, the content selection module 335 determines a measure of relevance of various content items to a user based on characteristics associated with the user by the venue management system 250 based on actions associated with the user by the venue management system 250, characteristics of the user maintained by the venue management system 250, preferences of the user maintained by the venue management system 250, and characteristics of content items eligible for presentation to the user. For example, the content selection module 335 determines measures of relevance to a user based on characteristics of the content items, characteristics of the user, and actions associated with the user. Based on the measures of relevance, the content selection module 335 selects one or more content items for presentation to the user (e.g., content items having at least a threshold measure of relevance, content items having highest measures of relevance relative to other content items). In some embodiments, the content selection module 335 ranks content items based on their associated measures of relevance and selects content items having the highest positions in the ranking or having at least a threshold position in the ranking for presentation to the user.

A content item may be associated with bid amounts specifying an amount of compensation received by the venue management system 250 from a third party system 130 or from a user if one or more criteria associated with the content item are satisfied. For example, a bid amount associated with a content item specifies an amount of compensation received by the venue management system 250 when the content item is presented to a user or when a user presented with the content item performs a specified type of interaction with the content item. The content selection module 335 uses the bid amounts associated with various content items when selecting content for presentation to the user. In various embodiments, the content selection module 335 determines an expected value associated with various content items based on their bid amounts and selects content items associated with a maximum expected value or associated with at least a threshold expected value for presentation to the user. An expected value associated with a content item represents an expected amount of compensation to the venue management system 250 for presenting a content item. For example, the expected value associated with a content item is a product of the content item's bid amount and a likelihood of the user interacting with the content item. The content selection module 335 may rank content items associated with bid amounts separately than content items that are not associated with bid amounts and select content items for presentation based on the separate rankings (e.g., content items having at least a threshold position in a ranking).

Additionally, the content selection module 335 receives information describing products provided by one or more vendors 120 and generates an interface describing the products that is transmitted to a client device 210 for presentation to a user via an application executing on the client device 210 that is associated with the venue management system 250. By generating the interface, the content selection module 335 may compensate for differences in how terminals used by different vendors 120 to identify products or services to users and provide an interface that presents information describing products provided by various vendors in a consistent format, simplifying user selection or purchase of products by purchased by a user via the interface. As further described below in conjunction with FIG. 3, to generate the interface, the content selection module 335 maintains formatting rules that map information describing one or more characteristics of products identified by a terminal 125 used by a vendor 120 to information describing formatting and presentation of the characteristics by the interface generated by the content selection module 335. For example, a formatting rule identifies types of characteristics of products received from a terminal and associates different types of characteristics with information describing presentation of the different types of characteristics; a formatting rule may identify positions of different types of characteristics relative to each other in an interface presented by the venue management system, so characteristics of a product are presented in a consistent order relative to each other even when different terminals 125 identify the product to the content selection module 335. In an embodiment, a formatting rule specifies presentation of a price of a product adjacent to a name of the product in the interface, while another formatting rules specifies that products having a specific value for a type of characteristic are presented in a region of the interface and products having an alternative value for the type of characteristic are presented in an another region of the interface. Hence, the formatting rules allow the interface generated by the content selection module 335 to present characteristics of products received from various terminals in a standardized order relative to each other or in standardized positions relative to each other.

As different terminals may use different values for types of characteristics of products, the content selection module 335 maintains different formatting rules for different terminals 125. For example, the content selection module 335 associates different sets of formatting rules with different identifiers of terminals 125 and retrieves a set of formatting rules corresponding to an identifier of a terminal from which product information was received. Maintaining different formatting rules for different terminals allows the content selection module 335 to account for variations in product information received from different terminals. Application of formatting rules to information received from a terminal 125 is further described below in conjunction with FIG. 4.

Additionally, the content selection module 335 may augment information about products received from a terminal 125 by obtaining characteristics of products identified by the terminal 125 from one or more sources other than the terminal 125. A source may be a third party system 230 external to the venue management system 250 or may be the venue management system 250. For example, the content selection module 335 obtains information describing characteristics of a product identified by a terminal 125 by communicating a request identifying the product to a third party system 230, which provides the information describing characteristics of the identified product to the content selection module 335. In various embodiments, the request to the third party system 230 includes a product identifier corresponding to a product, a name of the product, a description of the product, or other information identifying the product to the third party system 230. The content selection module 335 may additionally or alternatively access information stored by the user profile store 305, the action log 315, or information accessible to the venue management system 250 by a third party system 230 (e.g., connections between users maintained by a third party system 230 that the users have authorized the venue management system 250 to access). For example, the content selection module 335 identifies prior purchases of a product by a user from the action log 325 or prior purchases of the product by other users connected to the user via a third party system 230 from the action log 315. Additionally, characteristics of one or more products may be obtained from information in the vendor management module 330 in various embodiments.

Various characteristics may be obtained by the content selection module 335 from the one or more sources, and different characteristics may be obtained for different types of identified products. For example, if an identified product is a food item, the content selection module 335 obtains one or more of: nutritional information of the identified product, ingredients of the identified product, and recipe information of the identified product. Different characteristics may be obtained from different sources. In the preceding example, nutritional information may be obtained from a particular website (i.e., a third party system 230), while recipe information may be obtained from a different website (i.e., a different third party system 230). As another example, if an identified product is an article of clothing, the content selection module 335 obtains one or more of: sizing information, care information, complementary articles of clothing from one or more sources. The content selection module 335 may also obtain reviews of various identified products from one or more sources other than the terminal. In some embodiments, the content selection module 335 obtains reviews of an identified product from different sources and determines an average of the reviews for the identified product. Alternatively, the content selection module 335 obtains reviews of an identified product from different sources and separately maintains the obtained reviews.

The content selection module 335 applies the one or more formatting rules to characteristics of products received from a terminal 125 and characteristics of products obtained from one or more sources to generate the interface. Hence, the content selection module 335 augments characteristics of products specified by a vendor 120 via the terminal 125 with additional characteristics obtained from the one or more sources, with the formatting rules identifying the types of characteristics presented by the interface. For example, application of the formatting rules generates an interface providing a menu of food items presenting a name and a price of a food item received from the terminal 125 in conjunction with nutritional information and ingredients of the food item obtained from one or more sources other than the terminal 125. Additionally, the formatting rules applied by the content selection module 335 modify presentation of information describing products based on information associated with a user to whom the interface is to be presented. For example, a formatting rule orders information describing products identified by the terminal 125 based on a number of times the user has previously purchased products or based on preferences in the user's user profile that match characteristics of different products. Generation of the interface is further described below in conjunction with FIG. 4.

The web server 340 links venue management system 250 via the network 220 to one or more client devices 210, as well as to one or more third party systems 230. Additionally, the web server 340 may exchange information between the venue management system 250 and one or more vendor systems 240. The web server 340 serves web pages, as well as other content, such as JAVA®, FLASH®, XML and so forth. The web server 340 may receive and route messages between the venue management system 250 and a client device 210, for example, instant messages, queued messages (e.g., email), text messages, short message service (SMS) messages, or messages sent using any other suitable messaging technique. A user may send a request to the web server 340 to upload information (e.g., images or videos) that are stored in the content store 210. Additionally, the web server 340 may provide application programming interface (API) functionality to send data directly to native client device operating systems, such as IOS®, ANDROID™, or BlackberryOS.

Generating an Interface Describing Products Provided by a Vendor Associated with a Venue

FIG. 4 is a flowchart of one embodiment of a method for generating an interface describing products provided by a vendor 120 associated with a venue 100. In other embodiments, the method may include different and/or additional steps than those described in conjunction with FIG. 4. Additionally, in other embodiments, steps of the method may be performed in orders different than the order described in conjunction with FIG. 4.

As further descried above in conjunction with FIG. 1, one or more vendors 120 are associated with a venue 110. Each vendor 120 provides products or services to users within the venue 110. Examples of vendors 120 include restaurants, food service providers, beverage providers, merchandise retailers, or other suitable entities providing products or services. Each vendor 120 uses one or more terminals 125 to identify products or services purchased by a user. Information received by a terminal 125 used by a vendor 120 to retrieve or to produce a product or to provide a service to a user who purchased the product or service. For example, the terminal 125 is a point of sale terminal identifying products provided by a vendor 120 and prices of various products provided by the vendor 120. When the terminal 125 receives an input selecting a product provided by the vendor 120, instructions identifying the selected product and a request to retrieve or to produce the selected product are provided to the vendor 120, prompting the vendor 120 to retrieve or to produce the selected product.

To allow users in a venue 100 to more easily order products or services from a vendor 120, a venue management system 250 provides an application executed by various client devices 110 that allows users to order products or services from one or more vendors 120 associated with the venue 100. However, terminals 125 used by different vendors 120 or used by vendors 120 in different venues 100 may differently identify products or services provided by different vendors 120, so the application provided by the vendor 120 differently presents information identifying products or services provided by different vendors 120 or provided by vendors 120 associated with different venues 100. For example, information identifying products or services from vendors 120 associated with different venues 100 may be presented in different orders or in different format in different orders or in different formats, which may increase a complexity of a user purchasing products or services via the application provided by the venue management system 250. However, to simplify purchase of products or services via the application provided by the venue management system 250 and executing on a client device 110, the venue management system 250 may generate an interface for presentation by the application based on information obtained from terminals 125 used by various vendors 120 associated with one or more venues 100.

The venue management system 250 receives 405 product information identifying products (or services) provided by a vendor 120 associated with one or more venues 100 from a terminal 125 used by the vendor 125. For example, the venue management system 250 receives 405 a listing of products and prices for various products from a point of sale (PoS) terminal 125 used by the vendor 120 to select products (or services) to provide to a user. In some embodiments, the venue management system 250 receives 405 product information when a terminal 125 is initially configured for use by the vendor 120 associated with a venue 100. Alternatively, the venue management system 250 receives 405 product information at periodic time intervals from the terminal 125 used by the vendor 120 associated with the venue 100. In other embodiments, the venue management system 250 receives 405 product information from the terminal 125 when product information maintained by the terminal 125 is modified. For example, when a product (or service) is removed or is added to the product information, or when the product information is modified (e.g., a price of a product is modified), the terminal 125 communicates the modified product information to the venue management system 250.

From the product information received 405 from the terminal 120, the venue management system 250 identifies 410 different products identified by the product information. For example, the venue management system 250 extracts product identifiers from the received product information and obtains information identifying products corresponding to different product identifiers from the vendor 120 or from information stored by the venue management system 250 (e.g., a directory or a catalog of products provided by the vendor 120). For one or more of the identified products, the venue management system 250 obtains 415 information describing characteristics of the identified products from one or more sources other than the terminal 125. A source may be a third party system 230 external to the venue management system 250 or may be the venue management system 250. For example, the venue management system 250 obtains 415 information describing characteristics of an identified product by communicating a request identifying the identified product to a third party system 230, which provides the information describing characteristics of the identified product to the venue management system 250. In various embodiments, the request to the third party system 230 includes a product identifier corresponding to an identified product to specify the identified product to the third party system 230. Alternatively, the request to the third party system 230 includes a name or a description of an identified product to specify the identified product to the third party system 230. The venue management system 250 may additionally or alternatively access information stored by the venue management system 250 based on the product identifier of the identified product, a name of the identified product, a description of the identified product, or any other suitable information specifying the identified product. In various embodiments, the venue management system 250 obtains 415 information describing characteristics of one or more identified products from multiple third party systems 230; in other embodiments, the venue management system 250 obtains 415 locally stored information describing characteristics of one or more identified products and obtains 415 information describing characteristics of one or more identified products from various third party systems 230. The information received 405 from the terminal 125 may identify one or third party systems 230 from which the venue management system 250 obtains 415 information describing characteristics of products (or services) provided by the vendor 120 using the terminal 125. Alternatively, the venue management system 250 maintains information identifying a set of third party systems 230 from which the venue management system 250 obtains 415 information describing characteristics of products (or services) provided by vendors 120 and obtains 415 information from one or more third party systems 230 in the set.

Various characteristics may be obtained 415 from the one or more sources, and different characteristics may be obtained for different types of identified products. For example, if an identified product is a food item, the venue management system 250 obtains 415 one or more of: nutritional information of the identified product, ingredients of the identified product, and recipe information of the identified product. Different characteristics may be obtained 415 from different sources. In the preceding example, nutritional information may be obtained 415 from a particular website (i.e., a third party system 230), while recipe information may be obtained from a different website (i.e., a different third party system 230). As another example, if an identified product is an article of clothing, the venue management system 250 obtains 415 one or more of: sizing information, care information, complementary articles of clothing from one or more sources. The venue management system 250 may also obtain 415 reviews of various identified products from one or more sources other than the terminal. In some embodiments, the venue management system 250 obtains 415 reviews of an identified product from different sources and determines an average of the reviews for the identified product. Alternatively, the venue management system 250 obtains 415 reviews of an identified product from different sources and separately maintains the obtained reviews.

Additionally, the venue management system 250 retrieves 420 one or more formatting rules that describe presentation of content by the venue management system 250. The formatting rules are locally maintained by the venue management system 250 in various embodiments. A formatting rule maps information describing one or more characteristics of products from the terminal 125 to information describing formatting and presentation of the characteristics by the venue management system 250. For example, a formatting rule identifies types of characteristics of products received 405 from the terminal 125 and associates different types of characteristics with information describing presentation of the different characteristics; a formatting rule may identify positions of different types of characteristics relative to each other in an interface presented by the venue management system 250. In an embodiment, a formatting rule specifies presentation of a price of a product adjacent to a name of the product in the interface, while another formatting rules specifies that products having a specific value for a type of characteristic are presented in a region of the interface and products having an alternative value for the type of characteristic are presented in an another region of the interface. Hence, the formatting rules allow the venue management system 250 to generate an interface where characteristics of products received 405 from various terminals 125 are presented in a standardized order relative to each other or are presented in standardized positions relative to each other.

As different terminals 125 may use different values for types of characteristics of products, the venue management system 250 maintains different formatting rules for different terminals 125. For example, the venue management system 250 associates different sets of formatting rules with different identifiers of terminals 125 and retrieves 425 a set of rules corresponding to an identifier of a terminal 125 from which product information was received 405. Maintaining different formatting rules for different terminals 125 allows the venue management system 250 to account for variations in product information received 405 from different terminals 125.

The venue management system 250 associates 425 characteristics from the obtained information with identified products from the product information corresponding to the characteristics. In various embodiments, the venue management system 250 associates 425 characteristics from the obtained information with a product identifier received 405 from the terminal 125 that is included in the obtained information. As another example, the venue management system 250 associates 425 characteristics from the obtained information with a product name or a product description received 405 from the terminal 125 that is included in the obtained information. The association allows the venue management system 250 to augment characteristics of an identified product included in the information received 405 from the terminal with characteristics of the product obtained 415 from one or more sources. For example, the venue management system 250 associates 425 components of a product obtained 415 from a third party system 230 with pricing information for the product received 405 from the terminal 125. As another example, if the product information identifies food items, the venue management system 250 associates 425 nutritional information for an identified food item obtained 420 from a third party system 230 and recipe information for the identified food item obtained 420 from an additional third party system 230 with pricing information for the identified food item received 405 from the terminal 125.

By applying the one or more formatting rules to the identified products from product information received 405 from the terminal 125 and the characteristics obtained 420 from the one or more sources and associated 425 with various identified products, the venue management system 250 generates 430 an interface describing the identified products and identifying characteristics obtained 420 from the one or more sources that are associated with at least a set of the identified products. Hence, the interface augments characteristics of products of the set received 405 from the terminal 125 with additional characteristics of products of the set obtained 415 from the one or more sources. In some embodiments, applying the one or formatting rules determines an order in which identified products are presented in the interface. For example, information describing identified products having specific characteristics or having specific values for characteristics is more prominently presented in the interface (e.g., presented in positions closer to an upper boundary of the interface, presented in a different font, color, or size than information describing other identified products).

Application of the one or more formatting rules may account for prior purchases of products from one or more vendors 120 by a user or by other users to whom the user is connected via a third party system 230 communicating with the venue management system 250. For example, a formatting rule orders information in the interface describing identified products based on prior purchases of identified products by a user to whom the interface is to be presented so information describing identified products that the user more frequently purchased is more prominently presented in the interface (e.g., presented nearer to an upper boundary of the interface). The formatting rule may rank identified products based on a number of purchases of various identified products by the user from the vendor 120 using the terminal 125 or based on a number of purchases of various identified products from multiple vendors 120 in various embodiments. Based on the ranking, the formatting rule orders information describing identified products so information describing identified products having higher positions in the ranking is more prominently displayed by the interface.

Another formatting rule orders information describing the set of the identified products based on prior purchases of identified products by additional users of the venue management system 250 connected to the user via a third party system 230 communicating with the venue management system 250. The formatting rule may rank identified products based on a number of purchases of various identified products by the additional users connected to the user from the vendor 120 using the terminal 125 or based on a number of purchases of various identified products from multiple vendors 120 by the additional users connected to the user in various embodiments. Based on the ranking, the formatting rule orders information describing identified products so information describing identified products having higher positions in the ranking is more prominently displayed by the interface. In some embodiments, one or more formatting rules include information identifying additional users who are connected to the user via the third party system 230 communicating with the venue management system 250 in the information describing one or more identified products of the set. For example, names or other identifying information of one or more additional users connected to the user via the third party system 230 communicating with the venue management system 250 who purchased an identified product of the set is presented in the interface as information describing the identified product of the set. As another example, a number of additional users connected to the user via the third party system 230 communicating with the venue management system 250 who purchased an identified product of the set is presented as information describing the identified product of the set.

Additionally, one or more formatting rules may order information describing identified products of the set based on information associated with a user to whom the interface is to be presented by the venue management system 250. For example, a user profile for a user to whom the interface is to be presented specifies one or more preferences of the user, and a formatting rule orders information describing the identified products of the set so identified products having one or more characteristics matching preferences of the user are more prominently presented in the interface. As an example, if the identified products of the set are food items and the user's user profile specifies a preference for vegetarian food, a formatting rule orders information describing the food items so food items with a characteristic indicating they are vegetarian are more prominently presented by the interface than food items that do not have a characteristic indicating they are vegetarian (e.g., food items with a characteristic indicating they are vegetarian are presented closer to an upper boundary of the interface).

The venue management system 250 transmits 435 the interface to a client device 210 executing an application associated with the venue management system 250 for presentation to a user. In some embodiments, the venue management system 250 generates 430 and transmits 435 the interface to the client device 210 in response to receiving a request for the interface from the client device 210. Hence, the venue management system 250 transmits 435 an interface that presents characteristics of various products provided by the vendor 120 in a format or an order determined by the venue management system 250, allowing the user to more easily identify products for purchase from a vendor 120 via the application associated with the venue management system 250 executing on the client device 210. Additionally, by obtaining 415 characteristics of one or more products provided by the vendor 120 from sources other than the terminal 125 and including the characteristics from the one or more sources in the interface, the venue management system 250 allows the user to better identify products provided by the vendor 120 that are relevant to the user.

If the venue management system 250 receives 405 product information identifying products provided by an additional vendor from from an additional terminal used by the additional vendor 120, the venue management system 250 similarity identifies 410 the products identified by the information received from the additional terminal 125, obtains 415 information from one or more sources describing characteristics of one or more of the identified products identified by the product information received 405 from the additional terminal 125. By applying the one or more formatting rules to the product information received 405 from the additional terminal 125 and the information obtained 415 from the one or more sources, the venue management system 250 generates 430 the interface describing at least a set of the products identified by the information received from the additional terminal 125 and including characteristics of one or more of the products that were obtained 415 from one or more sources other than the additional terminal. Additionally, application of the one or more formatting rules allows the venue management system 250 to present information describing products provided by vendors using different terminals 125 in a more uniform format by presenting characteristics of various products in a uniform order or arrangement regardless of the terminal 125 from which the venue management system 250 received 405 information identifying products provided by a vendor 120.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving product information at a venue management system from a terminal used by a vendor associated with a venue, the product information identifying products provided by the vendor;
identifying the products identified by the product information;
obtaining information describing characteristics of one or more of the identified products from one or more sources other than the terminal;
retrieving one or more formatting rules maintained by the venue management system, the one or more formatting rules describing presentation of content;
associating characteristics from the obtained information with corresponding identified products;
generating an interface describing the identified products by applying the one or more formatting rules to the product information, the interface including information describing at least a set of the identified products and identifying characteristics from the obtained information associated with one or more of the identified products of the set; and
transmitting the interface to a client device executing an application associated with the venue management system for presentation to a user.

2. The method of claim 1, wherein a source comprises a third party system external to the venue management system.

3. The method of claim 2, wherein a characteristic of an identified product comprises a review of the identified product.

4. The method of claim 2, wherein a characteristic of an identified product is selected from a group consisting of: nutritional information of the identified product, ingredients of the identified product, recipe information of the identified product, and any combination thereof.

5. The method of claim 1, wherein the source comprises the venue management system.

6. The method of claim 5, wherein a characteristic of an identified product is a number of prior purchases of the identified product.

7. The method of claim 5, wherein a characteristic of an identified product comprises information identifying one or more additional users connected to the user through a third party system that communicates with the venue management system who previously purchased the identified product.

8. The method of claim 1, wherein one or more formatting rules order information describing the set of the identified products based on prior purchases of identified products by the user so information describing identified products that the user more frequently purchased are more prominently presented in the interface.

9. The method of claim 1, wherein one or more formatting rules order information describing the set of the identified products based on prior purchases of identified products by additional users of the venue management system connected to the user via a third party system that communicates with the venue management system so information describing identified products more frequently purchased by the additional users are more prominently presented in the interface.

10. The method of claim 1, further comprising:
receiving product information at a venue management system from an additional terminal used by an additional vendor associated with an additional venue, the product information identifying products provided by the additional vendor;
identifying the products identified by the product information from the additional terminal;
obtaining information describing characteristics of one or more of the products identified by the product information from the additional terminal from one or more sources; and
generating the interface describing the products identified by the product information from the additional terminal by applying the one or more formatting rules to the product information identified by the product information from the additional terminal, the interface including information describing at least a set of the products identified by the product information from the additional terminal and identifying characteristics of one or more of the products identified by the product information from the additional terminal from the obtained information.

11. A computer program product comprising a computer readable storage medium having instructions encoded thereon that, when executed by a processor, cause the processor to:
receive product information at a venue management system from a terminal used by a vendor associated with a venue, the product information identifying products provided by the vendor;
identify the products identified by the product information;
obtain information describing characteristics of one or more of the identified products from one or more sources other than the terminal;
retrieve one or more formatting rules maintained by the venue management system, the one or more formatting rules describing presentation of content;
associate characteristics from the obtained information with corresponding identified products;
generate an interface describing the identified products by applying the one or more formatting rules to the product information, the interface including information describing at least a set of the identified products and identifying characteristics from the obtained information associated with one or more of the identified products of the set; and
transmit the interface to a client device executing an application associated with the venue management system for presentation to a user.

12. The computer program product of claim 11, wherein a source comprises a third party system external to the venue management system.

13. The computer program product of claim 12, wherein a characteristic of an identified product comprises a review of the identified product.

14. The computer program product of claim 12, wherein a characteristic of an identified product is selected from a group consisting of: nutritional information of the identified product, ingredients of the identified product, recipe information of the identified product, and any combination thereof.

15. The computer program product of claim 11, wherein the source comprises the venue management system.

16. The computer program product of claim 15, wherein a characteristic of an identified product is a number of prior purchases of the identified product.

17. The computer program product of claim 15, wherein a characteristic of an identified product comprises information identifying one or more additional users connected to the user through a third party system that communicates with the venue management system who previously purchased the identified product.

18. The computer program product of claim 11, wherein one or more formatting rules order information describing the set of the identified products based on prior purchases of identified products by the user so information describing identified products that the user more frequently purchased are more prominently presented in the interface.

19. The computer program product of claim 11, wherein one or more formatting rules order information describing the set of the identified products based on prior purchases of identified products by additional users of the venue management system connected to the user via a third party system that communicates with the venue management system so information describing identified products more frequently purchased by the additional users are more prominently presented in the interface.

20. The computer program product of claim 11, wherein the computer readable storage medium further has instructions encoded thereon that, when executed by the processor, cause the processor to:
receive product information at a venue management system from an additional terminal used by an additional vendor associated with an additional venue, the product information identifying products provided by the additional vendor;
identify the products identified by the product information from the additional terminal;
obtain information describing characteristics of one or more of the products identified by the product information from the additional terminal from one or more sources; and
generate the interface describing the products identified by the product information from the additional terminal by applying the one or more formatting rules to the product information identified by the product information from the additional terminal, the interface including information describing at least a set of the products identified by the product information from the additional terminal and identifying characteristics of one or more of the products identified by the product information from the additional terminal from the obtained information.
